(19) United States
(12) Patent Application Publication
(10) Pub. No.: US 2017/0055747 A1
(43) Pub. Date: Mar. 2, 2017

(54) Personal Apparel Assembly

(71) Applicant: Tanya K. Webster, Burnsville, MN (US)

(72) Inventor: Tanya K. Webster, Burnsville, MN (US)

(21) Appl. No.: 14/833,430

(22) Filed: Aug. 24, 2015

(51) Int. Cl. A47G 25/14; A41D 27/20; A41D 27/08; F21V 23/04; B65D 85/18; B65D 85/00; F21V 33/00; A41B 1/08; B43K 29/10

(52) U.S. Cl. CPC A47G 25/1407; A41B 1/08; A41D 27/20; A41D 27/08; B43K 29/10; B65D 85/185; B65D 85/70; F21V 33/0048; F21V 23/04

(57) ABSTRACT

A personal apparel assembly includes an article of clothing that may be worn. A pen is provided and the pen may be used in the convention of writing. A lighting circuit is positioned within the pen such that the lighting circuit may selectively illuminate an area. A display unit has the article of clothing suspended therefrom. Thus, the display unit may display the article of clothing to an observer.

### BACKGROUND OF THE DISCLOSURE

Field of the Disclosure

The disclosure relates to apparel devices and more particularly pertains to a new apparel device for displaying an article of clothing that celebrates the Rhodesian Ridgeback.

### SUMMARY OF THE DISCLOSURE

An embodiment of the disclosure meets the needs presented above by generally comprising an article of clothing that may be worn. A pen is provided and the pen may be used in the convention of writing. A lighting circuit is positioned within the pen such that the lighting circuit may selectively illuminate an area. A display unit has the article of clothing suspended therefrom. Thus, the display unit may display the article of clothing to an observer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a personal apparel assembly according to an embodiment of the disclosure.

FIG. 2 is a front perspective view of an embodiment of the disclosure.

FIG. 3 is a front view of an embodiment of the disclosure.

FIG. 4 is a left side view of an embodiment of the disclosure.

FIG. 5 is a top perspective view of an embodiment of the disclosure.

FIG. 6 is a perspective view of an embodiment of the disclosure.

### DESCRIPTION OF THE PREFERRED EMBODIMENT

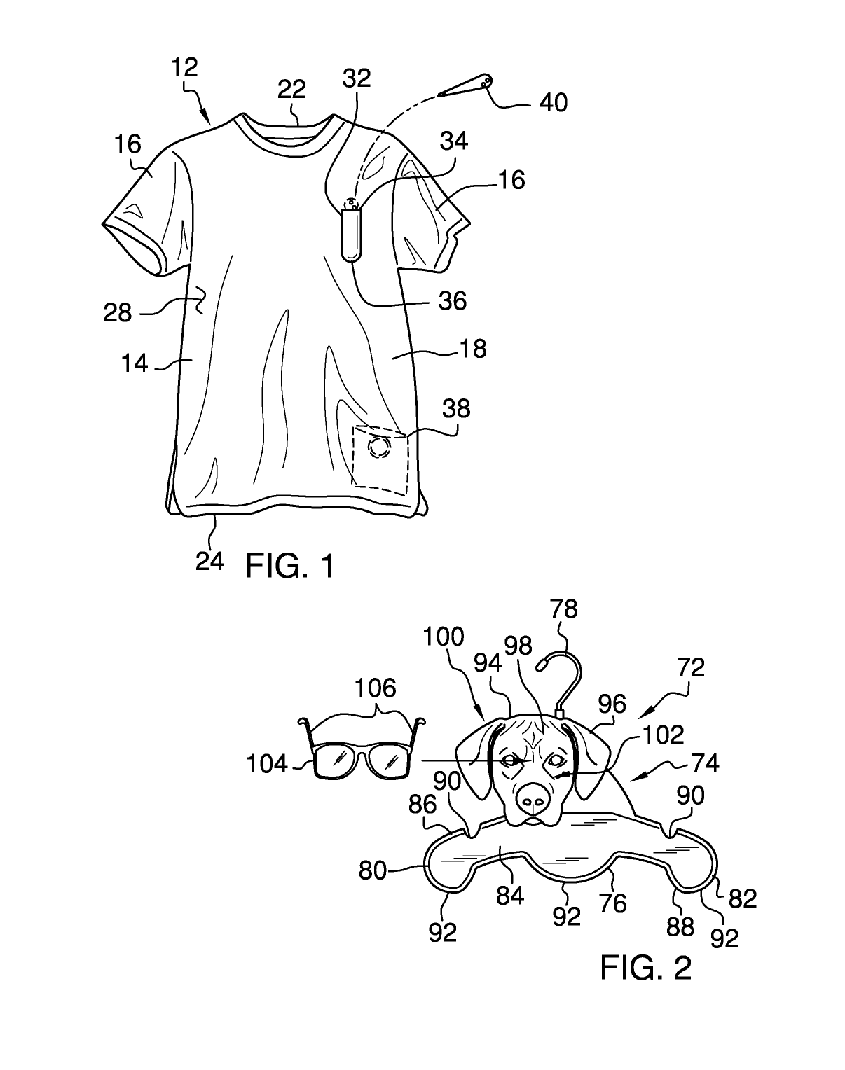

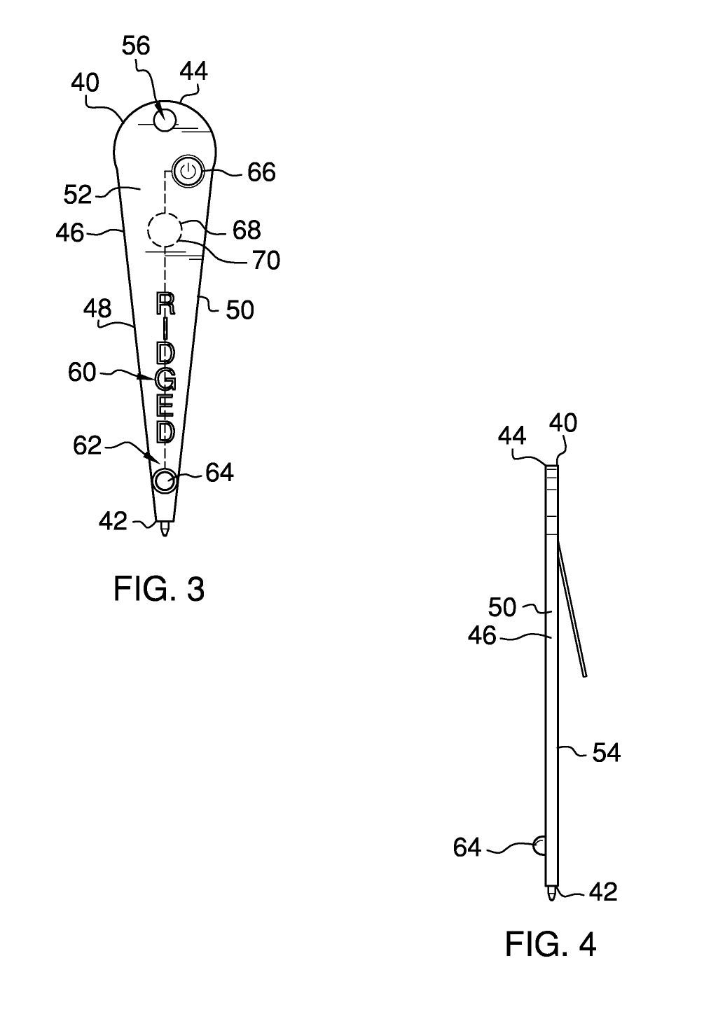

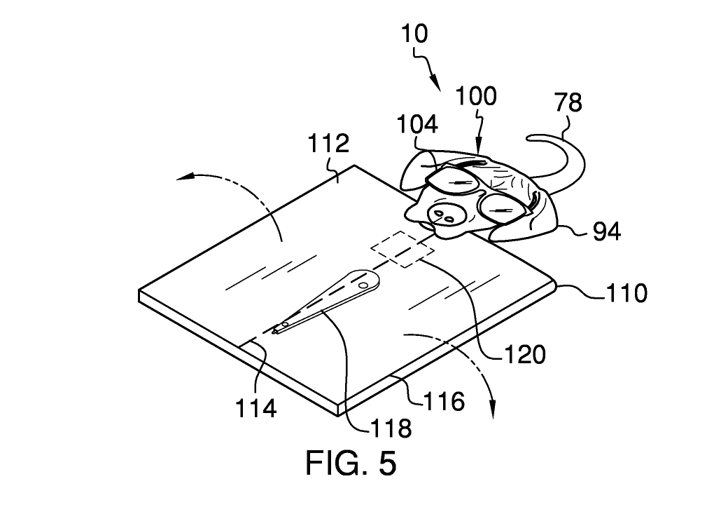

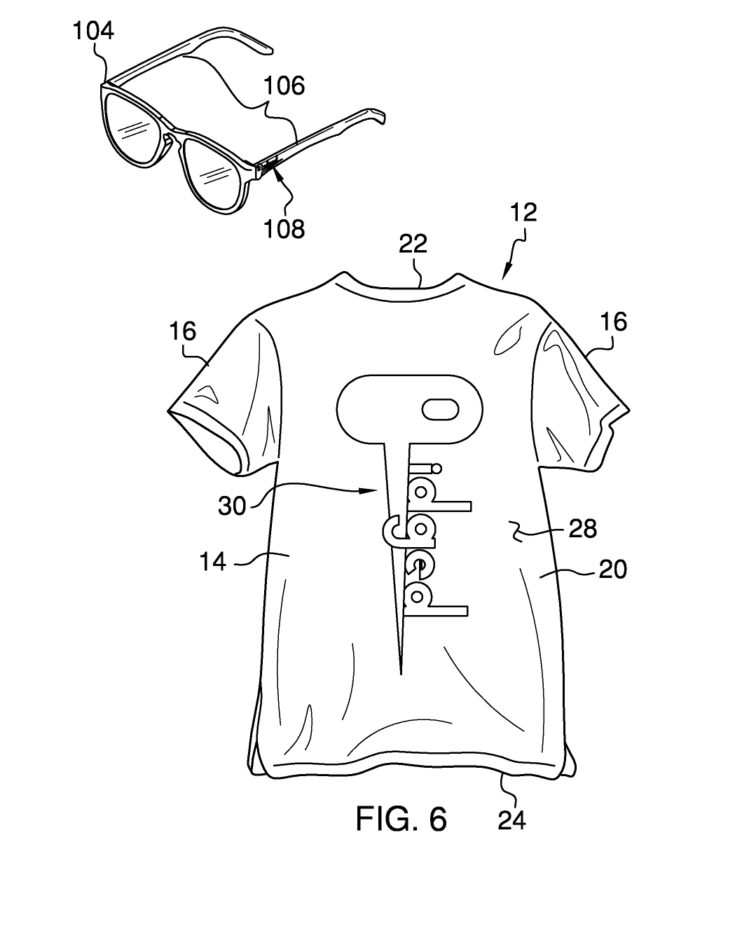

With reference now to the drawings, and in particular to FIGS. 1 through 6 thereof, a new apparel device embodying the principles and concepts of an embodiment of the disclosure and generally designated by the reference numeral 10 will be described.

As best illustrated in FIGS. 1 through 6, the personal apparel assembly 10 generally comprises an article of clothing 12 that may be worn. The article of clothing 12 has a body 14 and a pair of sleeves 16. The body 14 has a front side 18, a back side 20, a top end 22 and a bottom end 24. The body 14 has an inner surface 26 and an outer surface 28. Each of the top end 22 and the bottom end 24 are open such that the article of clothing 12 may be worn in the convention of a shirt. Each of the sleeves 16 extends away from opposite sides of the article of clothing 12. Thus, each of the sleeves 16 may insertably receive an associated one of a pair of arms.

The outer surface 28 corresponding to the back side 20 has indicia 30 printed thereon. The indicia 30 comprise an image of a stripe in an animal's fur. The animal may be a dog. The dog may be a Rhodesian Ridgeback and the indicia 30 may comprise the stripe on the dog's back that is unique to Rhodesian Ridgebacks. The article of clothing 12 may comprise a tee shirt or the like.

The article of clothing 12 has a first pocket 32 that is positioned on the outer surface 28 corresponding to the front side 18. The first pocket 32 is positioned closer to the top end 22 than the bottom end 24. The first pocket 32 is positioned adjacent to one of the sleeves 16. The first pocket 32 has an upper end 34 and a lower end 36 and the upper end 34 is open. The first pocket 32 is elongated between the upper end 34 and the lower end 36. The article of clothing 12 has a second pocket 38 that is positioned on the inner surface 26 corresponding to the front side 18. The second pocket 38 may store an object and the second pocket 38 is positioned adjacent to the bottom end 24.

A pen 40 is provided and the pen 40 may be used in the convention of writing. The pen 40 has a first end 42, a second end 44 and a peripheral wall 46 extending between the first end 42 and the second end 44. The peripheral wall 46 has a first lateral side 48, a second lateral side 50, a front side 52 and a back side 54. Each of the first lateral side 48 and the second lateral side 50 angle outwardly between the first end 42 and the second end 44. The second end 44 is rounded such that the pen 40 has a tear drop shape.

The pen 40 has an opening 56 extending through the front side 52 and the back side 54. The opening 56 may selectively engage a support thereby facilitating the pen 40 to be suspended from the support. The front side 52 has indicia 60 printed thereon. The indicia 60 may comprise the word “Ridged”.

A lighting circuit 62 is positioned within the pen 40 such that the lighting circuit 62 may selectively illuminate an area. The lighting circuit 62 comprises a light emitter 64 that is positioned on the front side 52 of the pen 40. The light emitter 64 emits light and the light emitter 64 may comprise an LED or the like. The light emitter 64 is positioned adjacent to the first end 42.

A switch 66 is positioned on the front side 52 of the pen 40 such that the switch 66 may be manipulated. The switch 66 is electrically coupled to the light emitter 64 such that the switch 66 turns the light emitter 64 on and off. A power supply 68 is positioned within the pen 40 and the power supply 68 is electrically coupled to the switch 66. The power supply 68 comprises at least one battery 70.

A display unit 72 is provided. The display unit 72 has the article of clothing 12 suspended therefrom. Thus, the display unit 72 may display the article of clothing 12 to an observer. The display unit 72 may be utilized for promotional purposes or for contest purposes.

The display unit 72 comprises a hanger 74 that has a body 76 and a hook 78. The body 76 has a first end 80, a second end 82, a forward side 84, a top edge 86 and a bottom edge 88. The top edge 86 has a pair of notches 90 extending downwardly therein. Each of the notches 90 is positioned adjacent to an associated one of the first end 80 and the second end 82 of the hanger 74.

The bottom edge 88 has a plurality of lobes 92 extending downwardly therefrom. The lobes 92 are spaced apart from each other and are distributed between the first end 80 and the second end 82 of the hanger 74. The hook 78 is coupled to and extends upwardly from the top edge 86. Thus, the hook 78 may engage a support thereby facilitating the hanger 78 to be suspended from the support.

A panel 94 is coupled to the hanger 74 and the panel 94 is positioned on the forward side 84 of the body 76. The panel 94 is positioned closer to the first end 76 of the body 76 than the second end 78 of the body 76. The panel 94 has a peripheral edge 96 and an exposed surface 98. The peripheral edge 96 is shaped such that the panel 94 resembles an animal head 100. The animal head 100 may be a dog's head and the dog's head may be a Rhodesian Ridgeback's head. The exposed surface 98 has indicia 102 printed thereon. The indicia 102 on the exposed surface comprise facial elements of the animal.

A pair of sunglasses 104 is provided and the sunglasses 104 have a pair of arms 106. Each of the arms 106 removably engages the panel 94 such that the pair of sunglasses 104 is retained on the panel 94. Each of the arms 106 has indicia 108 printed thereon. The indicia 108 on the arms 106 comprise a logo and the logo may include the word “Ridged”.

A box 110 is provided that has a front side 112 and the front side 112 has a perforation 114 extending longitudinally along the front side 112. The front side 112 has an inner surface 116 and the inner surface 116 has a well 118 extending outwardly therein. The box 110 is positionable on the hanger 74 such that the article of clothing 12 is contained within the box 110 when the article of clothing 12 is positioned on the hanger 74. The pen 40 is positioned within the well 118 when the box 110 is positioned on the hanger 74 such that the pen 40 is stored within the well 118. The perforation 114 may be torn thereby facilitating the box 110 to be removed from the hanger 74.

A sound emitter 120 is coupled to the box 110. The sound emitter 120 may comprise an electronic sound emitter that emits a pre-recorded sound. The pre-recorded sound may be the sound of a barking Rhodesian Ridgeback. The sound emitter 120 is in communication with the front side 112 such that the sound emitter 120 senses when the perforation 114 is torn. The sound emitter 120 may communicate with the front side 112 through any conventional means utilized by sound emitting greeting cards. The sound emitter 120 emits the pre-recorded sound when the perforation 114 is torn.

In use, the sunglasses 104 are positioned on the panel 94, the article of clothing 12 is suspended from the hanger 74, the pen 40 is positioned within the well 118 and the box 110 is positioned on the hanger 74 to enclose the article of clothing 12. The hook 78 is suspended from the support such that the panel 94 and the sunglasses 104 are visible to the observer. The perforation 114 is torn and the article of clothing 12 is removed from the hanger 74 thereby facilitating the article of clothing 12 to be worn.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal apparel assembly comprising:
an article of clothing being configured to be worn;
a pen being configured to be used in the convention of writing;
a lighting circuit being positioned within said pen wherein said lighting circuit is configured to selectively illuminate an area; and
a display unit having said article of clothing being suspended therefrom wherein said display unit is configured to display said article of clothing to an observer.

2. The assembly according to claim 1, wherein said article of clothing has a body and a pair of sleeves, said body having a front side, a back side, a top end and a bottom end, said body having an inner surface and an outer surface, each of said top end and said bottom end being open wherein said article of clothing is configured to be worn in the convention of a shirt, each of said sleeves extending away from opposite sides of said article of clothing wherein each of said sleeves is configured to insertably receive an associated one of a pair of arms.

3. The assembly according to claim 2, wherein said outer surface corresponding to said back side has indicia being printed thereon, said indicia comprising an image of a stripe in an animal's fur.

4. The assembly according to claim 2, wherein said article of clothing has a first pocket being positioned on said outer surface corresponding to said front side, said first pocket being positioned closer to said top end than said bottom end, said first pocket being positioned adjacent to one of said sleeves, said first pocket having an upper end and a lower end, said upper end being open, said first pocket being elongated between said upper end and said lower end.

5. The assembly according to claim 1, wherein said article of clothing has a second pocket being positioned on said inner surface corresponding to said front side wherein said second pocket is configured to store an object, said second pocket being positioned adjacent to said bottom end.

6. The assembly according to claim 1, wherein:
said pen has a first end, a second end and a peripheral wall extending between said first end and said second end, said peripheral wall having a first lateral side, a second lateral side, a front side and a back side, each of said first lateral side and said second lateral side angling outwardly between said first end and said second end, said second end being rounded such that said pen has a tear drop shape, said pen being positionable within a first pocket; and
said pen has an opening extending through said front side and said back side wherein said opening is configured to selectively engage a support thereby facilitating said pen to be suspended from the support.

7. The assembly according to claim 6, wherein said lighting circuit comprises a light emitter being positioned on said front side of said pen wherein said light emitter is configured to emit light, said light emitter being positioned adjacent to said first end.

8. The assembly according to claim 7, further comprising a switch being positioned on said front side of said pen wherein said switch is configured to be manipulated, said switch being electrically coupled to said light emitter such that said switch turns said light emitter on and off.

9. The assembly according to claim 8, further comprising a power supply being positioned within said pen, said power supply being electrically coupled to said switch, said power supply comprising at least one battery.

10. The assembly according to claim 1, wherein said display unit comprises a hanger having a body and a hook, said body having a first end, a second end, a forward side, a top edge and a bottom edge, said top edge having a pair of notches extending downwardly therein, each of said notches being positioned adjacent to an associated one of said first end and said second end of said hanger, said bottom edge having a plurality of lobes extending downwardly therefrom, said lobes being spaced apart from each other and being distributed between said first end and said second end of said hanger.

11. The assembly according to claim 10, wherein said hook is coupled to and extends upwardly from said top edge wherein said hook is configured to engage a support thereby facilitating said hanger to be suspended from the support.

12. The assembly according to claim 10, further comprising a panel being coupled to said hanger, said panel being positioned on said forward side of said body, said panel being positioned closer to said first end than said second end, said panel having a peripheral edge and an exposed surface, said peripheral edge being shaped such that said panel resembles an animal head, said exposed surface having indicia being printed thereon, said indicia on said exposed surface comprising facial elements of the animal.

13. The assembly according to claim 12, further comprising a pair of sunglasses, said sunglasses having a pair of arms, each of said arms removably engaging said panel such that said pair of sunglasses is retained on the panel, each of said arms having indicia being printed thereon, said indicia on said arms comprising a logo.

14. The assembly according to claim 10, further comprising a box having a front side, said front side having a perforation extending longitudinally along said front side, said front side having an inner surface, said inner surface having a well extending outwardly therein, said box being positionable on said hanger such that said article of clothing is contained within said box when said article of clothing is positioned on said hanger, said pen being positioned within said well when said box is positioned on said hanger such that said pen is stored within said well, said perforation being configured to be torn thereby facilitating said box to be removed from said hanger.

15. A personal apparel assembly comprising:
an article of clothing being configured to be worn, said article of clothing having a body and a pair of sleeves, said body having a front side, a back side, a top end and a bottom end, said body having an inner surface and an outer surface, each of said top end and said bottom end being open wherein said article of clothing is configured to be worn in the convention of a shirt, each of said sleeves extending away from opposite sides of said article of clothing wherein each of said sleeves is configured to insertably receive an associated one of a pair of arms, said outer surface corresponding to said back side having indicia being printed thereon, said indicia comprising an image of a stripe in an animal's fur, said article of clothing having a first pocket being positioned on said outer surface corresponding to said front side, said first pocket being positioned closer to said top end than said bottom end, said first pocket being positioned adjacent to one of said sleeves, said first pocket having an upper end and a lower end, said upper end being open, said first pocket being elongated between said upper end and said lower end, said article of clothing having a second pocket being positioned on said inner surface corresponding to said front side wherein said second pocket is configured to store an object, said second pocket being positioned adjacent to said bottom end;
a pen being configured to be used in the convention of writing, said pen having a first end, a second end and a peripheral wall extending between said first end and said second end, said peripheral wall having a first lateral side, a second lateral side, a front side and a back side, each of said first lateral side and said second lateral side angling outwardly between said first end and said second end, said second end being rounded such that said pen has a tear drop shape, said pen having an opening extending through said front side and said back side wherein said opening is configured to selectively engage a support thereby facilitating said pen to be suspended from the support;
a lighting circuit being positioned within said pen wherein said lighting circuit is configured to selectively illuminate an area, said lighting circuit comprising:
a light emitter being positioned on said front side of said pen wherein said light emitter is configured to emit light, said light emitter being positioned adjacent to said first end,
a switch being positioned on said front side of said pen wherein said switch is configured to be manipulated, said switch being electrically coupled to said light emitter such that said switch turns said light emitter on and off, and
a power supply being positioned within said pen, said power supply being electrically coupled to said switch, said power supply comprising at least one battery;
a display unit having said article of clothing being suspended therefrom wherein said display unit is configured to display said article of clothing to an observer, said display unit comprising:
a hanger having a body and a hook, said body having a first end, a second end, a forward side, a top edge and a bottom edge, said top edge having a pair of notches extending downwardly therein, each of said notches being positioned adjacent to an associated one of said first end and said second end of said hanger, said bottom edge having a plurality of lobes extending downwardly therefrom, said lobes being spaced apart from each other and being distributed between said first end and said second end of said hanger, said hook being coupled to and extending upwardly from said top edge wherein said hook is configured to engage a support thereby facilitating said hanger to be suspended from the support,
a panel being coupled to said hanger, said panel being positioned on said forward side of said body, said panel being positioned closer to said first end than said second end, said panel having a peripheral edge and an exposed surface, said peripheral edge being shaped such that said panel resembles an animal head, said exposed surface having indicia being printed thereon, said indicia on said exposed surface comprising facial elements of the animal,
a pair of sunglasses, said sunglasses having a pair of arms, each of said arms removably engaging said panel such that said pair of sunglasses is retained on the panel, each of said arms having indicia being printed thereon, said indicia on said arms comprising a logo, and
a box having a front side, said front side having a perforation extending longitudinally along said front side, said front side having an inner surface, said inner surface having a well extending outwardly therein, said box being positionable on said hanger such that said article of clothing is contained within said box when said article of clothing is positioned on said hanger, said pen being positioned within said well when said box is positioned on said hanger such that said pen is stored within said well, said perforation being configured to be torn thereby facilitating said box to be removed from said hanger.
